(19) United States
(12) Patent Application Publication
(10) Pub. No.: US 2010/0263629 A1
(43) Pub. Date: Oct. 21, 2010

(54) FUEL INJECTION VALVE

(75) Inventors: Jun Kondo, Nagoya-city (JP); Tomoki Fujino, Okazaki-city (JP); Shu Kagami, Nagoya-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 12/761,482

(22) Filed: Apr. 16, 2010

(30) Foreign Application Priority Data
Apr. 17, 2009 (JP) 2009-100553

(51) Int. Cl. F02M 57/00

(52) U.S. Cl. 123/445

(57) ABSTRACT

A fuel injection valve includes a body, a fuel pressure sensor, and a weld. The body has a passage to introduce high pressure fuel toward an injection hole. The fuel pressure sensor has a strain element and a sensor element so as to detect a pressure of the fuel. The strain element has an elastic deformation by receiving a pressure of the fuel. The sensor element converts an amount of the elastic deformation into a signal. The weld is defined by welding the body and the strain element. The fuel pressure sensor is mounted to the body through the weld.

### CROSS REFERENCE TO RELATED APPLICATION

This application is based on Japanese Patent Application No. 2009-100553 filed on Apr. 17, 2009, the disclosure of which is incorporated herein by reference in its entirety.

### BACKGROUND OF THE INVENTION

1. Field of the Invention

The present invention relates to a fuel injection valve.

2. Description of Related Art

JP-A-2008-144749, JP-A-2009-57926 or JP-A-2009-57927 discloses a fuel injection valve. While a fuel injection is performed, a pressure of fuel is varied, such that an actual injection state can be detected by detecting the variation of the pressure.

For example, when a fuel injection is started, its actual starting timing can be detected by detecting a starting timing of a pressure lowering. When a fuel injection is ended, its actual ending timing can be detected by detecting an ending timing of a pressure rising. Further, an amount of fuel injected in the fuel injection is required to be accurately controlled. If a fuel injection is accurately controlled, an output torque and emission of an internal combustion engine can be accurately controlled.

If a fuel pressure sensor is directly mounted to a common-rail, a pressure variation detected by the sensor is affected by the common-rail, such that the pressure variation cannot accurately be detected. Therefore, the fuel pressure sensor is mounted to a fuel injection valve, so as to accurately detect the pressure variation.

JP-A-2008-144749, JP-A-2009-57926 or JP-A-2009-57927 discloses a fuel pressure sensor mounted to a fuel injection valve, but does not disclose a specific position of the fuel pressure sensor.

For example, a strain element of the sensor is connected to a body of the fuel injection valve by screwing the strain element. The strain element has an elastic deformation by receiving a pressure of fuel, and a pressure variation of fuel is detected by detecting the elastic deformation of the strain element.

However, a size of the body may become large, because the body needs a space for the screwing of the strain element.

Further, a circular position of the strain element is unspecified, because of the screwing of the strain element. However, it is necessary for the strain element to have an electric connection with a circuit board arranged outside of the fuel pressure sensor. Therefore, the strain element may have a complicated construction for the electric connection, because the circular position of the strain element is unspecified.

### SUMMARY OF THE INVENTION

In view of the foregoing and other problems, it is an object of the present invention to provide a fuel injection valve.

According to an example of the present invention, a fuel injection valve includes a body, a fuel pressure sensor, and a weld. The body has a passage to introduce high pressure fuel toward an injection hole to inject fuel. The fuel pressure sensor has a strain element and a sensor element so as to detect a pressure of the fuel. The strain element has an elastic deformation by receiving a pressure of the fuel. The sensor element converts an amount of the elastic deformation of the strain element into a signal. The weld is defined between the body and the fuel pressure sensor by welding the body and the strain element of the fuel pressure sensor. The fuel pressure sensor is mounted to the body through the weld.

Accordingly, a size of the fuel injection valve can be made small, and a construction of the fuel pressure sensor can be made simple.

### BRIEF DESCRIPTION OF THE DRAWINGS

The above and other objects, features and advantages of the present invention will become more apparent from the following detailed description made with reference to the accompanying drawings. In the drawings:

FIG. 1 is a cross-sectional view illustrating a fuel injection valve according to a first embodiment;

FIG. 2A is an enlarged cross-sectional view illustrating a stem of the fuel injection valve before having a welding, and FIG. 2B is an enlarged cross-sectional view illustrating a weld of the fuel injection valve after the welding is performed;

FIG. 3A is a plan view illustrating the stem of the first embodiment having an electrical connection with a circuit board, and FIG. 3B is a plan view illustrating a comparison example;

FIG. 4A is an enlarged cross-sectional view illustrating a stem of a fuel injection valve according to a second embodiment before having a welding, and FIG. 4B is an enlarged cross-sectional view illustrating a weld of the fuel injection valve of the second embodiment after the welding is performed; and

FIG. 5 is an enlarged cross-sectional view illustrating a comparison example.

### DETAILED DESCRIPTION OF PREFERRED EMBODIMENT

### First Embodiment

A fuel injection valve 10 is used in a common-rail fuel injection system of a diesel engine, for example.

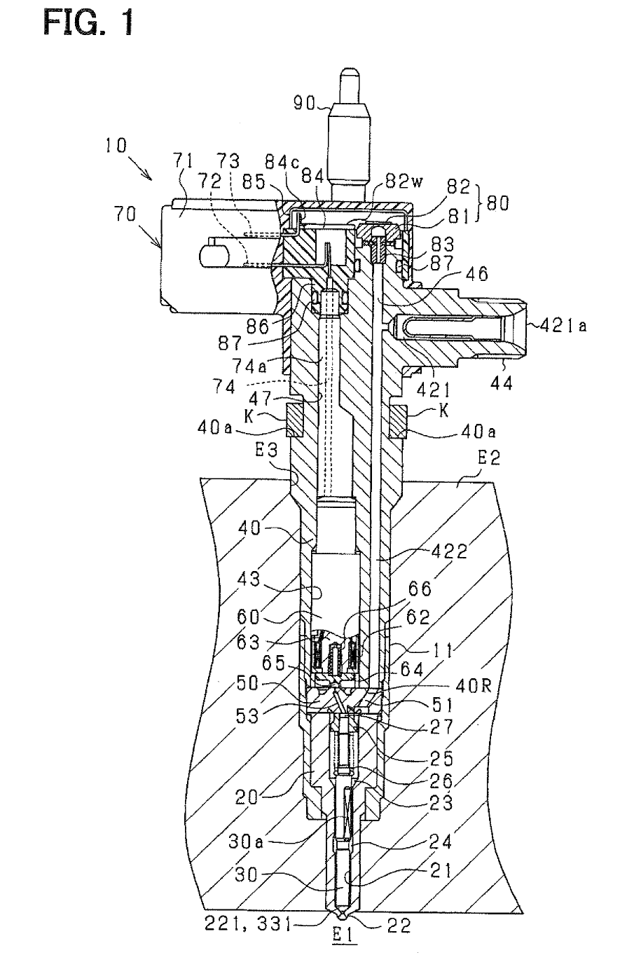

As shown in FIG. 1, the fuel injection valve 10 is arranged in a cylinder head E2 of the engine. Fuel is supplied from a common-rail, and the valve 10 directly injects the supplied fuel into a combustion chamber E1 of each cylinder of the engine.

The fuel injection valve 10 includes a nozzle body 20, a needle 30, a main body 40, an orifice plate 50, an electromagnetic unit 60, and so on.

The nozzle body 20, and a part of the main body 40 are arranged in an insertion hole E3 defined in the cylinder head E2. The main body 40 has an engaging face 40a to be engaged with a first end of a clamp K. When a second end of the clamp K is tightened toward the cylinder head E2 by a bolt, the first end of the clamp K is pressed to the engaging face 40a, such that the main body 40 is fitted into the insertion hole E3. Thus, the fuel injection valve 10 is pressed into the insertion hole E3, and is fixed in this state.

The nozzle body 20 is fixed to a lower side of the main body 40 through the orifice plate 50 by using a retaining nut 11. The nozzle body 20 has a guide hole 21 and an injection hole 22. The guide hole 21 is a chamber for slidably accommodating the needle 30. Fuel is injected through the injection hole 22, when the needle 30 is lifted up.

The guide hole 21 penetrates the nozzle body 20 from an upper end face toward a lower edge. A high pressure passage 23 is defined by a clearance between an inner circumference face of the guide hole 21 and an outer circumference face of the needle 30 so as to introduce high pressure fuel into the injection hole 22. The guide hole 21 has a fuel-pooling chamber 24 at which an inner diameter of the nozzle body 20 is made larger. An upstream end of the high pressure passage 23 is open to the upper end face of the nozzle body 20, and is connected to a high pressure passage 51 of the orifice plate 50.

A cone-shaped seat face 221 is defined on an inner circumference face of the nozzle body 20 at a position corresponding to the lower edge of the high pressure passage 23. The needle 30 has a seat face 331 to be seated on the seat face 221 of the nozzle body 20. When the seat face 331 of the needle 30 is seated on the seat face 221 of the nozzle body 20, the needle 30 closes and blocks the high pressure passage 23 from the injection hole 22.

A cylinder 25 is arranged in the guide hole 21, and a spring 26 is arranged between a lower end face of the cylinder 25 and an upper end face of the needle 30. The spring 26 presses the needle 30 in a valve-closing direction corresponding to a downward direction of FIG. 1. A back pressure chamber 27 is defined on an inner circumference face of the cylinder 25 so as to provide a back pressure to the upper end face of the needle 30. The back pressure corresponds to a high pressure of fuel. Due to the back pressure, the needle 30 is biased in the valve-closing direction. In contrast, the needle 30 is biased in a valve-opening direction corresponding to an upward direction of FIG. 1, due to a high pressure of fuel in the fuel-pooling chamber 24.

The main body 40 has an approximately column shape, and a high pressure port 44 is defined on an outer circumference face of the main body 40. The high pressure port 44 is a connector to be connected to a high pressure pipe (not shown). A low pressure connector 90 is mounted on an upper end face of the main body 40, so as to be connected to a low pressure pipe (not shown). Fuel is supplied from a common-rail through the high pressure pipe to the high pressure port 44. The supplied fuel is taken into the main body 40 through the outer circumference face, and excess fuel is discharged from the main body 40 through the upper end face and the connector 90.

The main body 40 has a high pressure passage 421, 422, a low pressure passage (not shown), a hole 43 accommodating the electromagnetic unit 60, a sensor passage 46, a hole 47 accommodating a lead wire, and so on. Due to the high pressure passage 421, 422, high pressure fuel introduced from the high pressure port 44 is further introduced into the high pressure passage 23 of the nozzle body 20 through the high pressure passage 51 of the orifice plate 50. The low pressure passage sends the excess fuel into the connector 90 from the back pressure chamber 27.

The high pressure passage 421, 422 is constructed by a first passage 421 and a second passage 422. A supply port 421a is defined on the outer circumference face of the main body 40 at a position corresponding to the high pressure port 44. The first passage 421 extends from the supply port 421a in a radial direction of the main body 40. The second passage 422 extends in an axis direction of the main body 40, and is defined between a downstream end of the first passage 421 and a lower end face 40R of the main body 40. The axis direction corresponds to a longitudinal direction of the fuel injection valve 10, and corresponds to an insertion direction of the fuel injection valve 10 inserted into the cylinder head E2.

The sensor passage 46 extends from an upstream end of the second passage 422 in a direction approximately opposite from the second passage 422. The unit-accommodating hole 43, the low pressure passage, the sensor passage 46, and the wire-accommodating hole 47 extend in the axis direction of the fuel injection valve 10.

The electromagnetic unit 60 and the second passage 422 are arranged in a direction approximately perpendicular to the axis direction of the main body 40. That is, the electromagnetic unit 60 and the second passage 422 are arranged in a left-and-right direction of FIG. 1.

The orifice plate 50 has a high pressure passage 51, an inlet passage (not shown) and an outlet passage 53. High pressure fuel flows through the high pressure passage 51, and flows into the back pressure chamber 27 through the inlet passage. The fuel flows out of the back pressure chamber 27 toward a low pressure side through the outlet passage 53. The inlet passage has an inlet orifice, and the outlet passage 53 has an outlet orifice.

The electromagnetic unit 60 has a stator 63, an armature 64, a ball valve 65, and so on. The stator 63 has an electromagnetic coil 62. The armature 64 is movable relative to the stator 63. The ball valve 65 is movable integrally with the armature 64 so as to open or close the outlet passage 53. The ball valve 65 may correspond to a controlling valve.

A connector 70 is mounted on the main body 40. The connector 70 has a connector housing 71 made of resin, and connector terminals 72, 73 held by the housing 71. The electromagnetic coil 62 and the connector terminal 72 are electrically connected to each other through a lead wire 74. The lead wire 74 is arranged in the hole 47 of the main body 40, and is supported by a supporting member 74a.

When electricity is supplied to the electromagnetic coil 62, the armature 64 is drawn to the stator 63, Further, the spring 66 applies an elastic force to the armature 64 in a direction of closing the ball valve 65, corresponding to a downward direction of FIG. 1. The spring 66 is located at a center part of the stator 63.

When fuel is injected from the injection hole 22, a pressure of fuel in the nozzle body 20 and the main body 40 is varied. A fuel pressure sensor 80 is mounted on an upper end face of the main body 40 so as to detect the variation of the pressure.

The pressure sensor 80 outputs a waveform corresponding to the detected pressure variation. When a fuel injection is started from the hole 22, a starting timing of a pressure lowering is detected based on the waveform, such that actual injection starting timing can be detected. When the fuel injection is ended, an ending timing of a pressure rising is detected based on the waveform, such that actual injection ending timing can be detected. Further, the maximum value of the pressure lowering can be detected based on the waveform, such that an amount of fuel injected in the fuel injection can be detected.

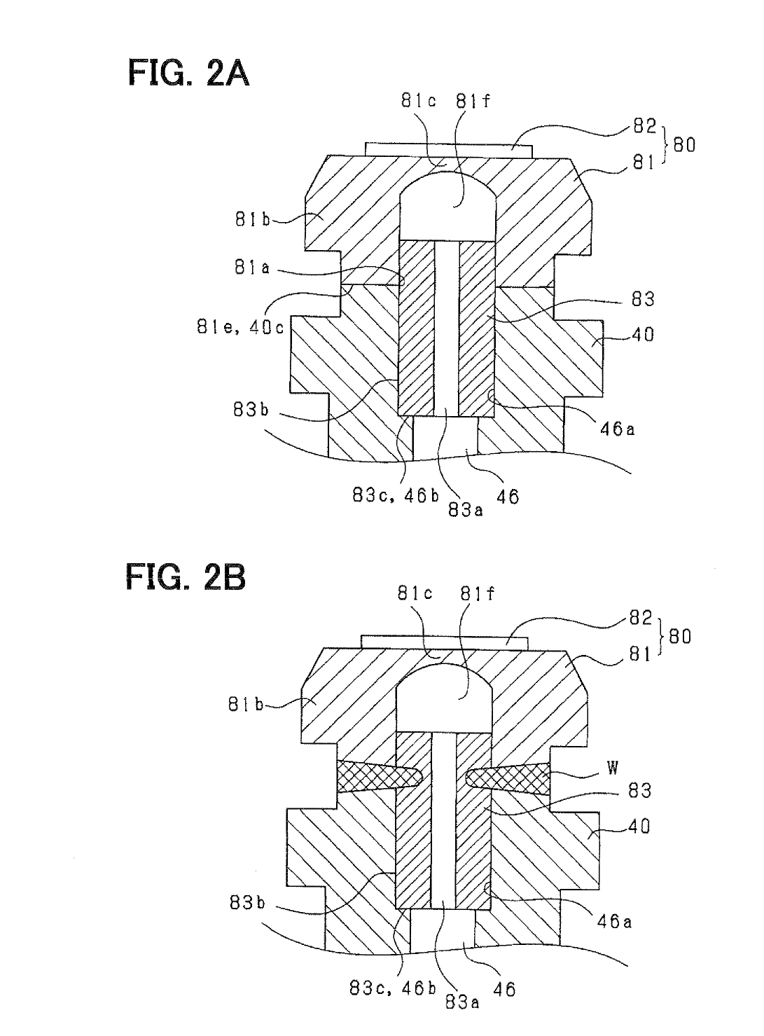

The fuel pressure sensor 80 will be described with reference to FIGS. 2A and 2B. FIG. 2A shows a stem 81 of the sensor 80 to be welded on the main body 40, and FIG. 2B shows the stem 81 welded on the main body 40.

The stem 81 may correspond to a strain element, and a strain gauge 82 of the sensor 80 may correspond to a sensor element. The sensor 80 is constructed by the stem 81 and the strain gauge 82. The stem 81 has an elastic deformation, when the stem 81 receives a pressure from fuel in the sensor passage 46. The gauge 82 converts the elastic deformation of the stem 81 into an electric signal, and outputs the signal as a pressure value.

The stem 81 has a cylinder portion 81b and a disk-shaped diaphragm 81c. An open end of the cylinder portion 81b is defined as an inlet 81a through which high pressure fuel is introduced into the stem 81. The diaphragm 81c closes the other open end of the cylinder portion 81b. A pressure of fuel flowing into the cylinder portion 81b through the inlet 81a is received by an inner face of the cylinder portion 81b and the diaphragm 81c. Therefore, the stem 81 has an elastic deformation as a whole.

The stem 81 is made of metal material having a high strength and a high hardness, because the stem 81 receives ultra-high pressure. Further, the metal material has less deformation generated by a thermal expansion, such that the gauge 82 is less affected by the thermal expansion. That is, the metal material has a relatively low thermal expansion coefficient. Specifically, the metal material may be Fe, Ni, or Co. Further, Ti, Nb or Al may be added into the metal material as a precipitation enforcing material. The stem 81 is produced by pressing, cutting or cold forging, for example. Further, C, Si, Mn, P or S may be added into the metal material.

Further, a metal tube member 83 is inserted into the inlet 81a. The sensor passage 46 has an enlarged part 46a at which an inner diameter of the sensor passage 46 is enlarged. A lower part of the tube member 83 is inserted into the enlarged part 46a. An upper end of an inner passage 83a of the tube member 83 is connected to an inner passage 81f of the cylinder portion 81b of the stem 81. A lower end of the inner passage 83a of the tube member 83 is connected to the sensor passage 46.

An outer circumference face 83b of the tube member 83 is tightly contact with inner circumference faces of the cylinder portion 81b and the sensor passage 46. A lower end face 83c of the tube member 83 is contact with a step face 46b of the enlarged part 46a, thereby a position of the tube member 83 is determined in the axis direction.

An end face 81e of the cylinder portion 81b is located to surround the inlet 81a, and is welded to an end face 40c of the main body 40 located adjacent to the enlarged part 46a. The end face 81e, 40c is approximately perpendicular to the axis direction, and extends in a radial direction from the inlet 81a. The sensor 80 is mounted to the main body 40, due to the welding.

The end face 81e, 40c has a ring shape surrounding the inlet 81a. Therefore, a sealing can be performed between the stern 81 and the main body 40 due to the welding. Thus, high pressure fuel can be restricted from leaking through a gap between the end faces 81e, 40c.

A procedure of the welding will be described. The tube member 83 is inserted into the enlarged part 46 of the main body 40, and the lower end face 83c of the tube member 83 is made to be contact with the step face 46b of the main body 40. The gauge 82 is mounted on the stem 81, and the cylinder portion 81b of the stem 81 is engaged with the upper part of the tube member 83. The end face 81e of the stem 81 is made to contact with the end face 40c of the main body 40. Thus, as shown in FIG. 2A, the tube member 83 and the stem 81 are mounted to the main body 40.

Laser light is radiated to the faces 81e, 40c from the outer circumference face toward the inner circumference face. Thus, the stem 81 is welded to the main body 40. A checkered weld W of FIG. 2B shows an area in which the stem 81 and the main body 40 are melted by the laser light.

The weld W has a depth in the radial direction. The laser light is controlled in a manner that the weld W reaches an approximately center position of a thickness of the tube member 83 in the radial direction. That is, the weld W is defined by a part of the tube member 83 other than the end faces 81e, 40c of the stem 81 and the main body 40.

The depth of the weld W is equal to or larger than a thickness of the stem 81 in the radial direction. Further, the depth of the weld W is equal to or larger than a sum of the thicknesses of the stem 81 and the tube member 83 in the radial direction.

The strain gauge 82 is mounted on the diaphragm 81c. When the stem 81 has an elastic deformation in an enlarging direction due to a pressure of fuel flowing into the inner passage 81f, the gauge 82 detects an amount of elastic deformation generated in the diaphragm 81c.

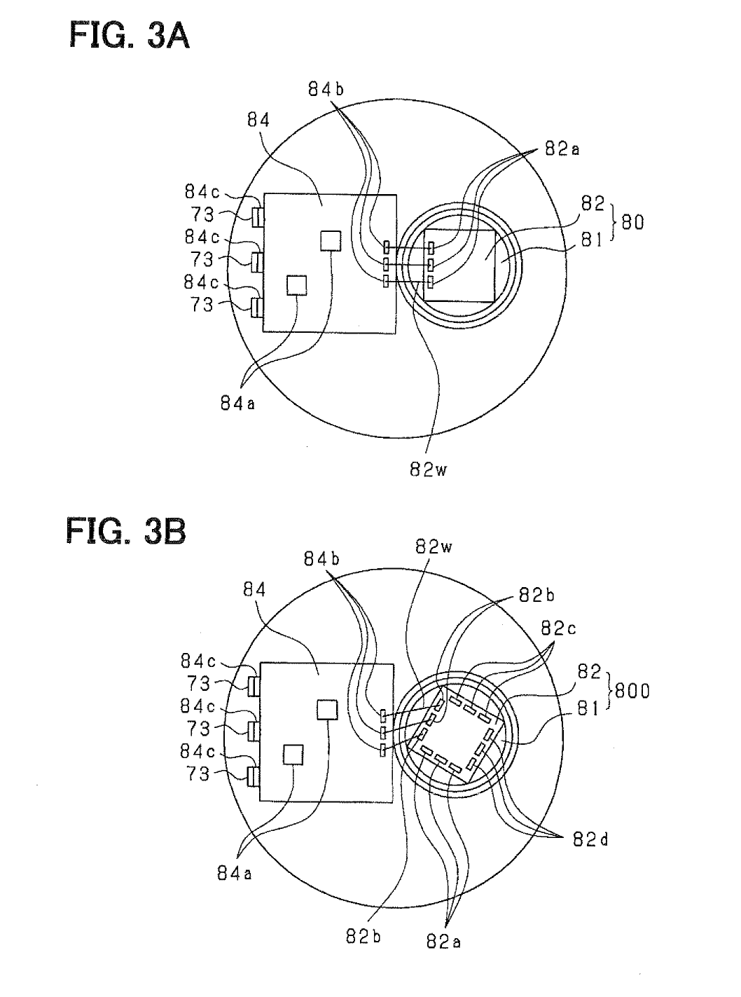

As shown in FIG. 1, a circuit board 84 is arranged on the main body 40. FIG. 3A shows a plan view of the circuit board 84 and the stem 81. A variety of electronic parts 84a are mounted on the circuit board 84. Further, electrode pads 84b and terminals 84c are arranged on the circuit board 84.

The electrode pad 84b is electrically connected to an electrode pad 82a of the strain gauge 82 through a wire bonding 82w. The terminal 84c is connected to the connecter terminal 73 through a welding.

A circular position of the stem 81 is determined in a manner that the electrode pad 82a of the gauge 82 opposes to the electrode pad 84b of the circuit board 84. The stem 81 is welded to the main body 40 in this state.

The electronic parts 84a may correspond to an amplifying circuit, a filtering circuit, and a power circuit, for example. The amplifying circuit amplifies a signal output from the gauge 82. The filtering circuit eliminates a noise overlapping with the signal. The power circuit applies voltage to the gauge 82.

When a voltage is applied to the gauge 82, a resistance of a bridge circuit of the gauge 82 is varied in accordance with a strain of the diaphragm 81c. A voltage output from the bridge circuit is input into the amplification circuit of the electronic parts 84a as a pressure detecting value. The amplification circuit amplifies the voltage, and the amplified signal is output from the connector terminal 73 through the terminal 84c.

The connector terminal 73 has a terminal for outputting a signal of the sensor 80, a terminal for supplying power source, and a terminal for grounding. An outside harness connector (not shown) connects the connector 70 and an outside equipment (not shown) such as an engine ECU. Signal output from the electronic parts 84a is input into the engine ECU through the outside harness connector.

As shown in FIG. 1, the electronic parts 84a and the gauge 82 are covered by a shield cover 85 made of metal. The shield cover 85 blocks outside noise so as to protect the electronic parts 84a and the gauge 82.

The connector terminals 72, 73 and the circuit board 84 are arranged in a resin member 86 formed by molding. The molded resin member 86 is mounted on the main body 40 through a sealing member 87.

The sensor 80, the shield cover 85 and the molded resin member 86 are connected by molding resin together with the main body 40. A part of the molded resin corresponds to the connector housing 71.

An operation of the fuel injection valve 10 will be described.

When electricity is not supplied to the electromagnetic coil 62, the ball valve 65 closes the outlet passage 53. At this time, a force biasing the needle 30 in the valve-closing direction is larger than a force lifting up the needle 30 in the valve-opening direction. The valve-closing force is constructed by a pressure of fuel in the back pressure chamber 27 and a biasing force of the spring 26. The valve-opening force is constructed by a pressure of fuel in the fuel-pooling chamber 24. The seat face 331 of the needle 30 is seated on the seat face 221 of the nozzle body 20, such that the high pressure passage 23 and the injection hole 22 are blocked from each other. Thus, fuel is not injected.

When electricity is supplied to the electromagnetic coil 62, the armature 64 is drawn by the magnetized stator 63. The armature 64 is moved toward the stator 63 against the biasing force of the spring 66. The ball valve 65 receives a pressure of fuel in the back pressure chamber 27, and opens the outlet passage 53. High pressure fuel in the back pressure chamber 27 is released to a low pressure side through the outlet passage 53, and the pressure of fuel in the back pressure chamber 27 is lowered. When the valve-opening force becomes larger than the valve-closing force in the valve-closing direction, the needle 30 is lifted up. High pressure fuel supplied to the fuel injection valve 10 from the common-rail is injected from the injection hole 22, after passing through the high pressure passage 42 of the main body 40, the high pressure passage 51 of the orifice plate 50, and the high pressure passage 23 of the nozzle body 20.

Advantages of the first embodiment will be described.

In a comparison example, a stem has a screw portion around an outer circumference face, and the stem is mounted to a main body by tightening the screw portion. In the comparison example, a screw portion is also needed around the main body, such that a size of the main body becomes large in a radial direction due to the screw portion.

In contrast, according to the first embodiment, the fuel pressure sensor 80 is mounted to the main body 40 by welding the stem 81 to the main body 40. Therefore, a screw portion is unnecessary in the first embodiment, such that a size of the main body 40 can be maintained to be small.

As shown in FIG. 3B, in the comparison example, a circular position of a stem 81 is unspecified, thereby a circular position of an electrode pad 82a of a strain gauge 82 is unspecified. Therefore, the stem 81 has plural such as four sets of the electrode pads 82a, 82b, 82c, 82d. An electrode pad 84b of a circuit board 84 is connected to the most adjacent electrode pad 82b, for example, through a wire bonding 82w. That is, the plural sets of the electrode pads 82a, 82b, 82c, 82d are necessary in the comparison example.

In contrast, according to the first embodiment, the fuel pressure sensor 80 is mounted to the main body 40 by welding the stem 81 to the main body 40. Therefore, as shown in FIG. 3A, the welding can be performed after the circular position of the stem 81 is determined, in a manner that the electrode pad 82a of the gauge 82 is located to oppose to the electrode pad 84b of the circuit board 84. Thus, the plural sets of the electrode pads are unnecessary in the first embodiment.

As shown in FIG. 2B, according to the first embodiment, the weld W has the ring shape to surround the inlet 81a. Therefore, a sealing between the stem 81 and the main body 40 can be performed by the weld W. Thus, high pressure fuel in the passage 81f, 83a, 46 can be restricted from leaking between the end faces 81e, 40c. Further, a sealing member to prevent the leaking is unnecessary in the first embodiment.

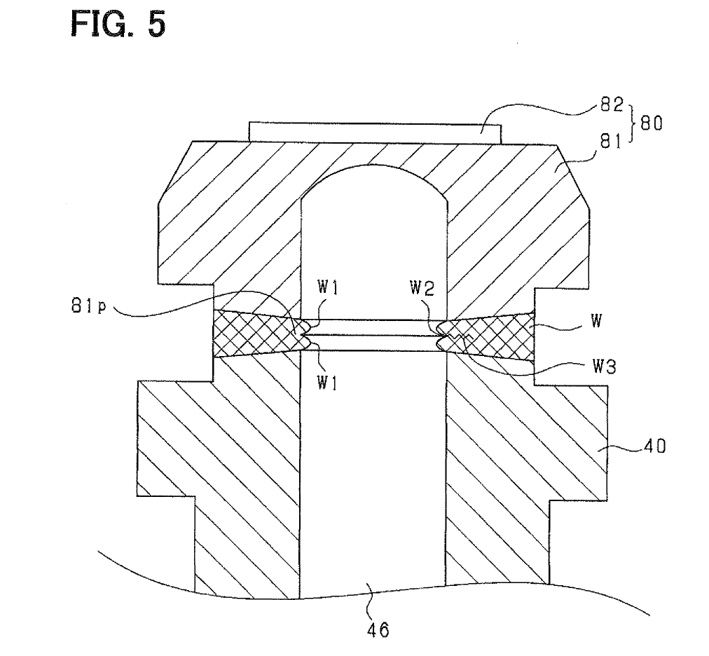

In a comparison example shown in FIG. 5, the tube member 83 is not arranged inside of the stem 81 and the main body 40. In a case that a resistance welding or laser welding is performed on an outer circumference face toward an inner circumference face, if an excess welding is performed, a pair of protrusions W1 is formed on the inner circumference faces of the body 40 and the stem 81. In the comparison example, the weld W may have a crack W3 from a border face W2 of the protrusions W1, due to a high pressure of fuel. The border face W2 may operate as a notch. In contrast, if the depth of the weld W is too small, the weld W may not be defined in a part 81p adjacent to the inner circumference face, such that poor welding may be generated. That is, the depth of the weld W is required to be accurately controlled in the comparison example.

In contrast, as shown in FIG. 2B, according to the first embodiment, the weld W is defined by welding the end face 81e, 40c of the stem 81 and the main body 40, and a part of the tube member 83. The weld W extends to an inside of the tube member 83 in the thickness direction. Therefore, the protrusion W1 and the crack W3 of FIG. 5 can be restricted from being generated in the first embodiment. That is, a poor welding can be restricted from being generated, because the weld W reaches the inner circumference face of the stem 81. Further, the depth of the weld W is not required to be accurately controlled in the first embodiment.

According to the first embodiment, the weld W is formed by using the laser welding. Therefore, a temperature increasing of the stem 81 can be made local during the welding, compared with a case in which a weld is formed by using a resistance welding. Even when the welding is performed in a state that the strain gauge 82 is mounted to the stem 81, the gauge 82 can be restricted from having a damage from heat generated by the welding.

According to the first embodiment, the gauge 82 can be mounted to the stem 81 before the welding. Therefore, a test of the sensor 80 can be performed before the sensor 80 is mounted to the main body 40. Thus, operating efficiency of the test can be increased.

According to the first embodiment, the stem 81 and the main body 40 are separately produced.

Therefore, in a case when an inner stress is generated in the main body 40 by a thermal expansion or shrinkage, the stress is less transmitted to the stem 81. That is, influence of a distortion of the main body 40 becomes small relative to the stem 81, when the stem 81 and the main body 40 are separately produced.

Therefore, when the gauge 82 is mounted to the stem 81, the gauge 82 can be restricted from being affected by the distortion of the main body 40, compared with a case in which a gauge is directly mounted to a main body. Thus, fuel pressure detecting accuracy of the sensor 80 can be raised.

The stem 81 and the main body 40 are separately produced, and a thermal expansion coefficient of the stem 81 is made smaller than that of the main body 40. Therefore, the stem 81 can be restricted from having a thermal expansion or shrinkage, such that a distortion of the stem 81 can be reduced. Further, a material cost can be reduced, because only the stem 81 is made of a material having a smaller thermal expansion coefficient, compared with a case in which a whole main body is made of the material having the smaller thermal expansion coefficient.

A test of the gauge 82 can be performed before the stem 81 is mounted to the main body 40, because the stem 81 and the main body 40 are separately produced. Thus, operating efficiency of the test can be increased.

### Second Embodiment

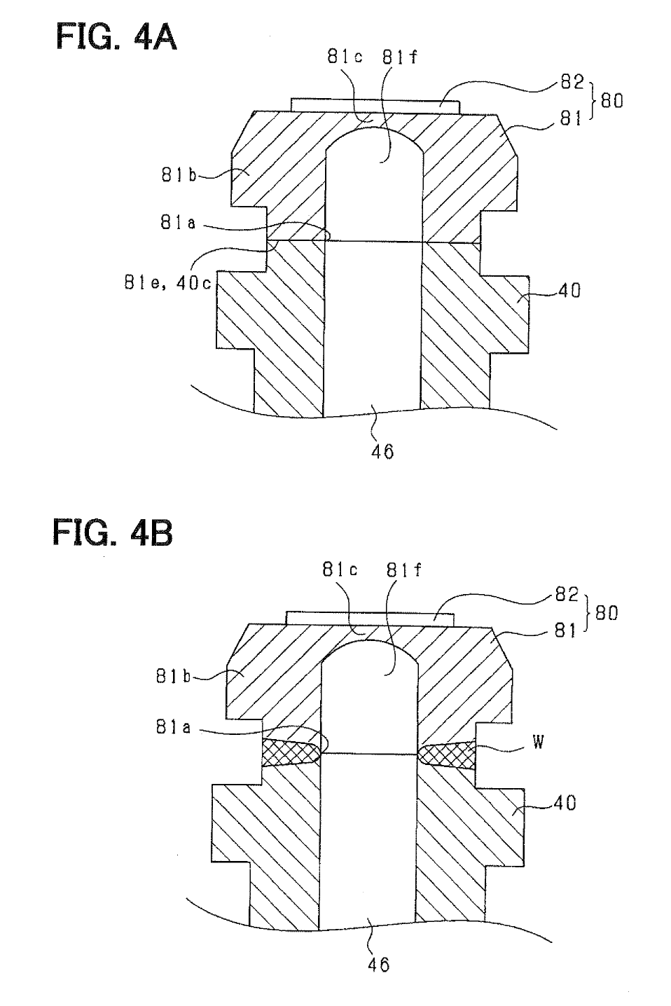

As shown in FIGS. 4A and 4B, the tube member 83 is eliminated in a second embodiment, compared with the first embodiment. When the end faces 81e, 40c are welded, the laser welding is controlled in a manner that the weld W extends from the outer circumference face to the inner circumference face of the cylinder portion 81b of the stem 81. An inner circumference face of the sensor passage 46 and an inner circumference face of the cylinder portion 81b are located on the same plane. That is, a diameter of the inner passage 81f of the stem 81 is approximately equal to a diameter of the sensor passage 46.

According to the second embodiment, approximately the same advantages can be obtained as the first embodiment. Further, the number of parts can be reduced, because the tube member 83 is eliminated. However, the depth of the weld W is required to be more accurately controlled in the second embodiment, compared with the first embodiment.

### Other Embodiment

The weld W is not limited to be formed by using the laser welding. Alternatively, the weld W may be formed by using a resistance welding.

The sensor passage 46 extends from the upstream end of the second passage 422 in the direction opposite from the second passage 422, and the stem 81 is welded to the upper end part of the main body 40. Alternatively, the sensor passage 46 may extend from a downstream end of the first passage 421 in the direction opposite from the first passage 421, and the stem 81 may be welded to an outer circumference part of the main body 40.

The sensor element to detect a strain of the stem 81 is not limited to the strain gauge 82. Alternatively, a piezoelectric element may be used to detect the strain of the stem 81.

An electric actuator to activate the needle 30 is not limited to the electromagnetic unit 60. Alternatively, a piezo-actuator may be used to activate the needle 30, in which multiple piezo-elements are stacked.

The fuel injection valve 10 is not limited to be used for an injector of the diesel engine. Alternatively, the valve 10 may be used for a gasoline engine to directly inject fuel into the combustion chamber E1.

Such changes and modifications are to be understood as being within the scope of the present invention as defined by the appended claims.

What is claimed is:

1. A fuel injection valve comprising:
a body having a passage to introduce high pressure fuel toward an injection hole to inject fuel;
a fuel pressure sensor to detect a pressure of the fuel, the sensor having
a strain element to have an elastic deformation by receiving a pressure of the fuel, and
a sensor element to convert an amount of the elastic deformation of the strain element into a signal; and
a weld defined between the body and the strain element by welding the body and the strain element, wherein
the fuel pressure sensor is mounted to the body through the weld.

2. The fuel injection valve according to claim 1, wherein
the strain element has
a cylinder portion, and
a diaphragm fixed on a first end part of the cylinder portion as a base of the cylinder portion, wherein
the cylinder portion has a second end part to surround a fuel inlet through which fuel flows into the strain element,
the sensor element is mounted on the diaphragm,
the weld is defined between the second end part of the cylinder portion and the body, and
the weld has a ring shape corresponding to the cylinder portion.

3. The fuel injection valve according to claim 2, further comprising:
a tube member arranged in the fuel inlet, in a manner that an outer circumference face of the tube member opposes to a weld face between the second end part of the cylinder portion and the body, wherein
the weld is defined by the weld face between the second end part of the cylinder portion and the body, and the tube member, by further melting the tube member, and
the weld extends to an inside of the tube member in a radial direction of the tube member.

4. The fuel injection valve according to claim 1, wherein
the weld is defined between the body and the fuel pressure sensor by using a laser welding.

5. The fuel injection valve according to claim 1, wherein
the body has an inner circumference face arranged on the same plane as an inner circumference face of the strain element.

6. The fuel injection valve according to claim 1, further comprising:
a tube member arranged in a manner that an outer circumference face of the tube member is fitted to an inner circumference face of the strain element, wherein
the weld has a depth equal to or larger than a thickness of the strain element in a radial direction, and
the depth of the weld is equal to or smaller than a sum of thicknesses of the strain element and the tube member.
